(19) United States
(12) Patent Application Publication
(10) Pub. No.: US 2016/0162522 A1
(43) Pub. Date: Jun. 9, 2016

(54) SYSTEMS AND METHODS FOR DETECTING DATA LEAKAGE IN AN ENTERPRISE

(71) Applicant: Chetan GANATRA, Kalyan West (IN)

(72) Inventor: Chetan GANATRA, Kalyan West (IN)

(73) Assignee: Wipro Limited, Bangalore (IN)

(21) Appl. No.: 14/636,588

(22) Filed: Mar. 3, 2015

(30) Foreign Application Priority Data
Dec. 8, 2014 (IN) 6173/CHE/2014

(51) Int. Cl. G06F 17/30; G06F 21/62

(52) U.S. Cl. CPC G06F 17/30321; G06F 17/3012; G06F 21/6245

(57) ABSTRACT

Systems and methods for detecting data leakage in an enterprise are described. In one implementation, the method comprises receiving files metadata from at least one device associated with the enterprise. The files metadata comprises a plurality of file parameters. Further, the method comprises processing the files metadata to generate indexed metadata. The indexed metadata comprises at least one of the plurality of file parameters. Further, the method comprises analyzing the indexed metadata based on predefined leakage patterns to detect the data leakage.

### PRIORITY CLAIM

This U.S. patent application claims priority under 35 U.S.C. §119 to: India Application No. 6173/CHE/2014, filed on Dec. 8, 2014. The entire contents of the aforementioned application are incorporated herein by reference.

### TECHNICAL FIELD

The present subject matter relates to detection of data leakage, and, particularly but not exclusively, to systems and methods for detecting data leakage in an enterprise.

### BACKGROUND

In an enterprise, critical computing facilities, such as Datacenter (DC), Offshore-Development Center (ODC), and Call center (CC) that deal with client related information are governed by strict policy compliance requirements. It is observed that even with best of solutions and policy enforcements, frequent client data leakage is reported and alleged by customers. Responding to such incident and allegations typically requires a huge amount of time and technical expertise.

Enterprises generally do not have a visibility of what level of information, important or not, is stored in user desktops across organization. Such information, if required, and whenever required, is retrieved using traditional mechanism of visiting individual desktop and capturing inventory of software files. Such physical response and detailed forensic investigation on each individual Desktop is time consuming and requires specialized skill sets. On an average, just a file system review of a desktop file names may take 6 to 8 hours approximately. Considering the number of systems per computing facility and the storage disk size per system, the time required even to check whether a file exist in a user environment is exceptionally large.

### SUMMARY

Disclosed herein are systems and methods for detecting data leakage in an enterprise. In one example, the system comprises a processor, a memory communicatively coupled to the processor, wherein the memory stores processor-executable instructions, which, on execution, cause the processor to receive files metadata from at least one device associated with the enterprise. The files metadata comprises a plurality of file parameters. The processor-executable instructions, on execution, further cause the processor to process the files metadata to generate indexed metadata. The indexed metadata comprises at least one of the plurality of file parameters. The processor-executable instructions, on execution, further cause the processor to analyze the indexed metadata based on predefined leakage patterns to detect the data leakage.

Certain embodiments of the present disclosure relates to a method for detecting data leakage in an enterprise comprises receiving files metadata from at least one device associated with the enterprise. The files metadata comprises a plurality of file parameters. Further, the method comprises processing the files metadata to generate indexed metadata. The indexed metadata comprises at least one of the plurality of file parameters. Further, the method comprises analyzing the indexed metadata based on predefined leakage patterns to detect the data leakage.

Certain embodiments of the present disclosure also relate to a non-transitory, computer-readable medium storing instructions for detecting data leakage in an enterprise that, when executed by a processor, cause the processor to perform operations comprises receiving files metadata from at least one device associated with the enterprise. The files metadata comprises a plurality of file parameters. Further, the operations comprise processing the files metadata to generate indexed metadata. The indexed metadata comprises at least one of the plurality of file parameters. Further, the operations comprise analyzing the indexed metadata based on predefined leakage patterns to detect the data leakage.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of a high-level architecture of an exemplary system for detecting data leakage, in accordance with some embodiments of the present disclosure.

FIG. 2 illustrate an exemplary computer implemented method for detecting data leakage, in accordance with some embodiments of the present disclosure.

FIG. 3 is a block diagram of an exemplary computer system for implementing embodiments consistent with the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Nowadays, some conventional systems are available to detect data leakage. These conventional systems employ heavy-duty backup solutions to frequently copy data from all user systems to central servers. Also, manually visit to user systems for generating inventory of informational data may be needed. Further, the conventional system may not be able to perform validation and ensure accuracy of important corporate information, such as Intellectual Property.

The present subject matter discloses systems and methods for detecting data leakage in an enterprise. The systems and methods may be implemented in a variety of computing systems. The computing systems that can implement the described method(s) include, but are not limited to a server, a desktop personal computer, a notebook or a portable computer, and a mainframe computer. Although the description herein is with reference to certain computing systems, the systems and methods may be implemented in other computing systems, albeit with a few variations, as will be understood by a person skilled in the art.

The present subject matter disclosed herein, to detect data leakage in an enterprise, receives files metadata from one or more devices associated with the enterprise. The files metadata may be then analyzed, based on various factors, such as data anomalies, unauthorized access to files, deviation from standard activities, detected data leakage incidents, replication of a file in multiple devices, and sequence of file system activities on an individual device and across multiple devices to detect the data leakage. Further, the present subject matter monitors activities performed by a user to determine user behavior in the enterprise.

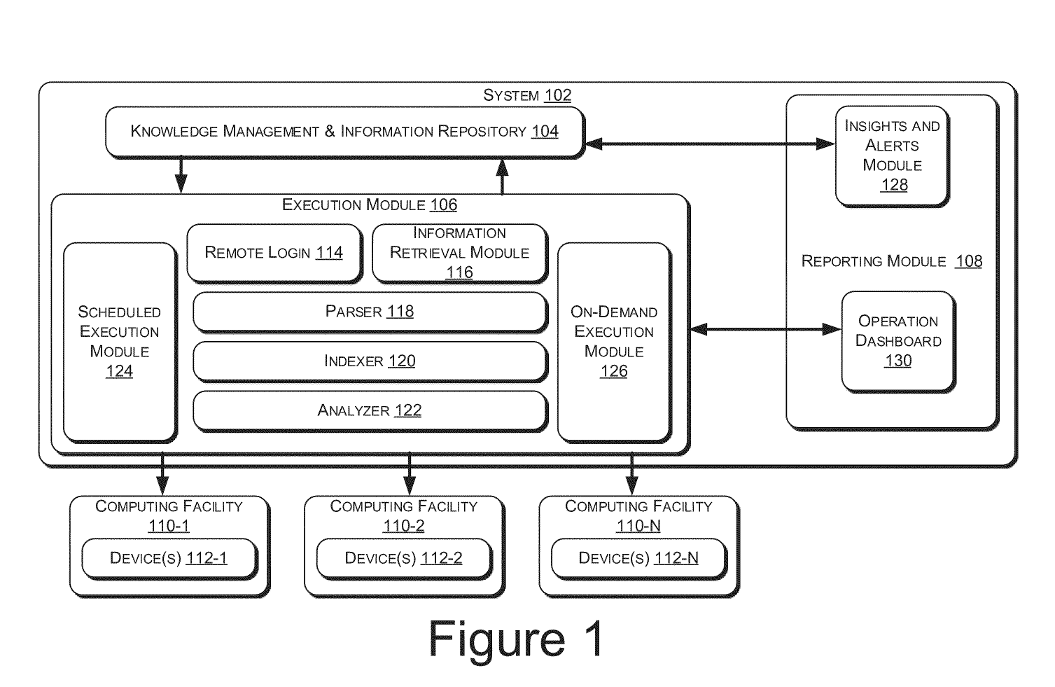

Working of the systems and methods for detecting data leakage in an enterprise is described in conjunction with FIGS. 1-3. It should be noted that the description and drawings merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and are to be construed as being without limitation to such specifically recited examples and conditions. Moreover, all statements herein reciting principles, aspects, and embodiments of the present subject matter, as well as specific examples thereof, are intended to encompass equivalents thereof. While aspects of the systems and methods can be implemented in any number of different computing systems environments, and/or configurations, the embodiments are described in the context of the following exemplary system architecture(s).

FIG. 1 illustrates a block diagram of a high-level architecture of an exemplary system 102 for detecting data leakage in an enterprise, in accordance with some embodiments of the present disclosure. The system 102 comprises a knowledge management and information repository (KMIR) 104, an execution module 106, and a reporting module 108. As shown in FIG. 1, the system 102 is communicatively coupled to a computing facility 110-1, a computing facility 110-2, and extended up to computing facility 110-N, individually referred to as computing facility 110 and collectively referred to as computing facilities 110. In an example, the computing facility 110 may be data processing and computing environments like Datacenter (DC), Offshore-Development Center (ODC) or Call center (CC) type of environments that deals with client related information and are governed by strict policy compliance requirements.

The computing facilities 110 comprise device(s) 112-1, 112-2, extended up to 112-N. The device(s) may be individually referred to as a device 112 and collectively referred to as devices 112. Example of the devices 112 include, but are not limited to, a desktop computer, a portable computer, a mobile phone, a handheld device, a workstation, and servers. The devices 112 may be used by various stakeholders or end users of the enterprise to which the computing facility 110 is associated. The end users may be employees of the enterprise/organization.

Further, as shown in FIG. 1, the execution module 106 and the reporting module 108 comprise sub-modules. The execution module 106 comprises a remote login 114, an information retrieval module 116, a parser 118, an indexer 120, an analyzer 122, a scheduled execution module 124, and an on-demand execution module 126. The reporting module comprises an insights and alerts (IA) module 128, and an operation dashboard 130.

In operations, to detect data leakage in the enterprise, the scheduled execution module 124 may initiate data retrieval from at least one device 112 associated with the enterprises at a predefined time. For example, the scheduled execution module 124 may instruct the information retrieval module 116 to obtain data for detecting data leakage every day at 11:00 pm. In one implementation, the on-demand execution module 126 may trigger information retrieval and detection of data leakage incidents upon receiving inputs from a system administrator. Hereinafter, the system administrator is used to refer a person who is using, controlling and monitoring the system 102. In an example, the system administrator may be a user of the system 102 from data security and risk team.

Once the remote login 114 receives instructions from the scheduled execution module 124 or on-demand execution module 126, the remote login 114 initiates a process for connecting and retrieving data from the devices 112 associated with the enterprise. The remote login 114 determines authentication parameters and establishes a connection with the devices 112 for data retrieval. In an example, devices 112 to which connectivity have to be established are determined based on the authentication parameters. Further, the authentication parameters may specify authentication mechanisms, credentials, available network bandwidth and memory from the devices 112. In an example, the remote login 114 may determine the authentication parameters based on inputs received from the system administrator.

Upon establishing the connection with the devices 112, the information retrieval module 116 may obtain files metadata from the devices 112 based on analysis parameters. The files metadata comprises a plurality of file parameters, such as type of file, file location, modification date, creation date, access date, timestamps maintained within a file system, file owner, file attributes, flags, and system identifier. In an example, only select metadata as indicated by analysis parameters may be extracted from the devices 112. Such metadata may further be locally processed to reduce the network transfer and storage overheads. For locally processing the retrieved metadata, techniques such as data structure optimization, processor multi-threading, in-memory compression and encryption may be employed.

Thereafter, the parser 118 receives the files metadata from the information retrieval module 116 and converts the files metadata into an indexable format. Such conversion may employ decompression, decryption and restructuring of data as may be applicable. Subsequently, the indexer 120 indexes the files data in the indexable format to obtain indexed metadata. In an example, the indexed metadata may comprise at least one of the plurality of files parameters. The indexer 120, while indexing the files metadata, may discard some files parameters that are not needed for analysis purpose. Therefore, it may be possible that the indexed metadata may comprise selected parameters from amongst the plurality of files parameters.

In one implementation, the indexer 120 may index the files metadata so that individual data elements can be assessed for an individual user across his/her own earlier data points as well as across other users in the computing facility 110. In an example, the indexer 120 may generate a view of user data activities by plotting data timelines and associated user activities.

Further, the analyzer 122 may analyze the indexed metadata based on predefined leakage patterns to detect the data leakage. In an example, the analyzer 122 may map the view, generated by the indexer 120, with the predefined leakage patterns to detect the data leakage. The data may be projected by the analyzer 122 based on known data leak patterns, such as time of day outside business hours, anomalous file creation, access or deletion. Examples of the predefined leakage patterns may comprise data anomalies, unauthorized access to files, deviation from standard activities, detected data leakage incidents, replication of a file in multiple devices 112, and sequence of file system activities on an individual device and across multiple devices 112. In an example, the predefined leakage patterns may be updated regularly based on automatic feedback received from previous analysis and the system administrator inputs.

In one example, if the indexed metadata indicates that a file is copied in multiple locations in a short time and shared to devices outside the enterprise networks, then the analysis module may flag the activity of multiple copies as suspicious. In another example, activity which matches data leak patterns, where files are created and subsequent deleted in a short period of time or during anomalous timings may be flagged for potential data leak. Similarly, creation of archive files with significant file sizes and deletion of the same within a short span may trigger data leak indicator for subsequent details analysis. In another instance, based on an ensemble of machine learning and anomaly detection algorithms, data leak patterns may be generated and used for analysis that may be file, user or environment specific. Such algorithms may comprise, but not limited to, usage of supervised as well as unsupervised machine learning algorithms, output of which is further summarized using data aggregation and statistical analysis.

Further, when the data leakage activity is detected and a second level of analysis is needed, in such cases, the analyzer 122 may instruct information retrieval module 116 to receive file content corresponding to suspicious/flagged files metadata from the device 112. To receive the file content, the information retrieval module 116 may establish a connection with the device 112 and extract the file content.

In one example, the analyzer 122 may track a data movement pattern, for users of the devices 112, based on the indexed metadata. The data movement pattern may indicate data related activities, such as movement, modification, creation, and deletion across various devices 112 for the users in the enterprise. Thereafter, the analyzer 122 may create a user profile based on three dimensions viz. user time lines, significant data movement activities across computing facility and known environment specific leak patterns. The user profile may indicate user behavior of the user in the enterprise.

Once the analysis is complete, the reporting module 108 may render a data leakage report to the system administrator. The data leakage report may comprise detected data leaks, potential data leaks, suspicious activities, and flagged activities.

The detected data leaks may include incidents where a pattern determined from the indexed metadata matches data leak triggers or the predefined leakage patterns.

The potential data leaks may include incidents where a pattern determined from the indexed metadata does not match data leak triggers or the predefined leakage patterns; however, indicates a high potential and resemblance to the data Leaks.

The suspicious activities may include incidents which fall under data leak type of patterns and anomalous activities done by users earlier triggered for the potential leaks.

The flagged activities may include incidents that could not be qualified as the data leak; however, are flagged for an informational analysis by the system administrator.

For each of categories identified in the data leakage report, the system administrator may drill down to individual data items to validate and infer if the observations are valid and any further details are needed. In case the system administrator opts to get additional details, available information as well as current (real-time) information may be again extracted and made available. Any successful or failed identification of data leak may be further used as a feedback to the predefined leakage patters and considered for subsequent analysis. Also, Inferences that are correctly flagged as the data leak may be used as feedback to enhance the score and confidence of the predefined leakage patterns. Similarly, any inferences that are proved to be incorrect may be used to refine and underscore the predefined leakage patterns.

The KMIR 104 may store all the data received from the indexer 120 and the analyzer 122. The KMIR 104 stores the view of the data activities and movement, the user profile, feedback received from the system administrator, the data leakage report, the predefined leakage patterns, and intermediary as well as final outputs generated by the execution module 106.

The IA module 128 communicates with the KMIR 104 and triggers alerts based on the data received from the KMIR 104. Once the analysis or detection of data leakage incidents is completed, the IA module 128 may generate output to the system administrator via reporting and dashboard.

The operation dashboard 130 provides for monitoring activities currently under process and identifies errors, deviations and anomalies. The operation dashboard 130 also provides an immediate alert in case data carved on the device 112 reads a data element that qualifies high priority leak.

Thus, the present subject matter detects the data leakage in an enterprise in a non-intrusive and speedy manner. Also, the present subject matter eliminates need to manually visit the devices 112 associated with the enterprise and generates inventory of informational data that can be used for offline detection of data leaks. The present subject matter pre-processes the files metadata by employing techniques such as restructuring, in-memory compression and reading data in parallel, thus ensuring that only limited data is required to be transferred and there by further reducing the time taken for retrieval. Further, the present subject matter creates a user profile to indicate user behavior and identify data movement patterns across computing facilities 110 in a non-intrusive manner. Further, since the system 102 extracts the files metadata, there is no need to deploy heavy-duty backup solutions to frequently copy data from all the devices 112, and analysis and detection of the data leakage is performed quickly.

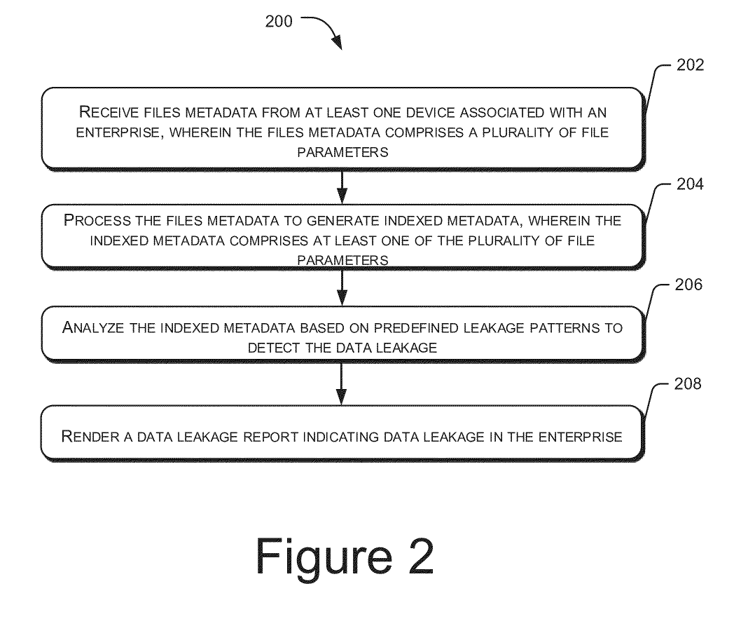

FIG. 2 illustrate an exemplary computer implemented method for detecting data leakage in an enterprise, in accordance with some embodiments of the present disclosure.

The method 200 may be described in the general context of computer executable instructions. Generally, computer executable instructions can include routines, programs, objects, components, data structures, procedures, modules, and functions, which perform particular functions or implement particular abstract data types. The method 200 may also be practiced in a distributed computing environment where functions are performed by remote processing devices that are linked through a communication network. In a distributed computing environment, computer executable instructions may be located in both local and remote computer storage media, including memory storage devices.

The order in which the method 200 is described is not intended to be construed as a limitation, and any number of the described method blocks can be combined in any order to implement the method 200 or alternative methods. Additionally, individual blocks may be deleted from the method 200 without departing from the spirit and scope of the subject matter described herein. Furthermore, the method 200 can be implemented in any suitable hardware, software, firmware, or combination thereof.

With reference to method 200 as depicted in FIG. 2, as shown in block 202, files metadata is received from the at least one device 112 associated with the enterprise. The files metadata comprises a plurality of file parameters. Examples of the plurality of files parameter may include type of file, file location, modification date, creation date, access date, timestamps maintained within a file system, file owner, file attributes, flags, or system identifier. In an example, the system 102 may establish a connection with the devices 112 in the computing facility 110 to detect the data leakage. While establishing the connection, the remote login 114 may transmit authentication parameters to the devices 112 to specify which devices 112 are to be targeted, how to establish a connection with the selected devices 112, and how to execute the information retrieval module. Further, analysis parameters are provided to information retrieval module 116 to specify what all information is needed for the analysis. Thereafter, the information retrieval module 116 may receive the files metadata from the devices 112.

In an example, the files metadata may be received for analysis on a regular interval of time as specified by the system administrator. In another example, the system administrator may initiate retrieval of the files metadata through the on-demand execution module 126.

At block 204, the files metadata is processed to generate indexed metadata. In an example, the parser 118 may receive the files metadata and covert into an indexable format. Thereafter, the indexer 120 may select the files parameter for analysis and obtain the indexed metadata by indexing the files metadata. The indexed metadata may comprise at least one of the plurality of file parameters. In an example, the indexer 120 may create a view of user data activities comprising data timelines and activities performed by a user.

At block 206, the indexed metadata is analyzed based on the predefined leakage patterns to detect the data leakage. Examples of the predefined leakage patterns may include data anomalies, unauthorized access to files, deviation from standard activities, detected data leakage incidents, replication of a file in multiple devices 112, and sequence of file system activities on an individual device and across multiple devices 112. In an example, the analyzer 122 may map the view, generated by the indexer 120, with the predefined leakage patterns to detect the data leakage. Further, the data movement pattern across the devices 112 in the enterprises may be monitored by the analyzer 122 for the users. In this manner, the analyzer 122 may create a user profile for each of the users based on the data movement pattern. The user profile may indicate user behavior and data activities in the enterprise which may allow the system administrator to easily interpret the information.

At block 208, a data leakage report indicating data leakage in the enterprise is rendered. The data leakage report comprises detected data leaks, potential data leaks, suspicious activities, and flagged activities. In an example, the reporting module 108 renders the data leakage report to the system administrator. Further, if the system administrator needs more information for analysis, the information retrieval module 114 may receive file content from the at least one device 112 for further analysis.

### Computer System

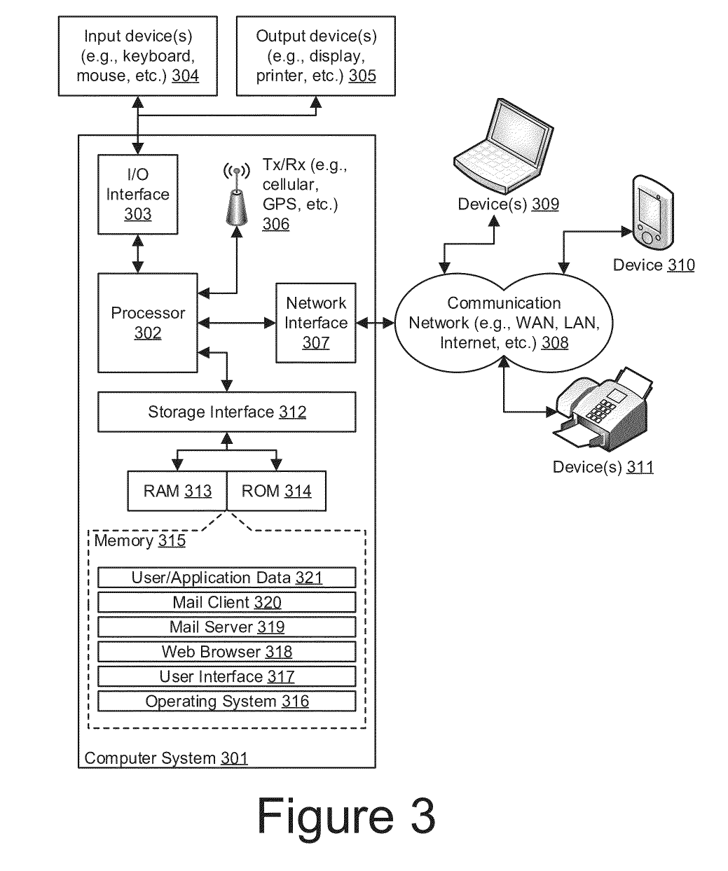

FIG. 3 is a block diagram of an exemplary computer system for implementing embodiments consistent with the present disclosure. Variations of computer system 301 may be used for implementing any of the devices presented in this disclosure. Computer system 301 may comprise a central processing unit (“CPU” or “processor”) 302. Processor 302 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 302 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 302 may be disposed in communication with one or more input/output (I/O) devices via I/O interface 303. The I/O interface 303 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 303, the computer system 301 may communicate with one or more I/O devices. For example, the input device 304 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 305 may be a printer, fax machine, video display (e.g., cathode ray tube (CRT), liquid crystal display (LCD), light-emitting diode (LED), plasma, or the like), audio speaker, etc. In some embodiments, a transceiver 306 may be disposed in connection with the processor 302. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 302 may be disposed in communication with a communication network 308 via a network interface 307. The network interface 307 may communicate with the communication network 308. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 308 may include, without limitation, a direct interconnection, local area network (LAN), wide area network (WAN), wireless network (e.g., using Wireless Application Protocol), the Internet, etc. Using the network interface 307 and the communication network 308, the computer system 301 may communicate with devices 310, 311, and 312. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 301 may itself embody one or more of these devices.

In some embodiments, the processor 302 may be disposed in communication with one or more memory devices (e.g., RAM 313, ROM 314, etc.) via a storage interface 312. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 316, user interface application 317, web browser 318, mail server 319, mail client 320, user/application data 321 (e.g., any data variables or data records discussed in this disclosure), etc. The operating system 316 may facilitate resource management and operation of the computer system 301. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 317 may facilitate display, execution, interaction, manipulation, or operation of program components through textual or graphical facilities. For example, user interfaces may provide computer interaction interface elements on a display system operatively connected to the computer system 301, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 301 may implement a web browser 318 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 301 may implement a mail server 319 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 301 may implement a mail client 320 stored program component. The mail client may be a mail viewing application, such as Apple Mail, Microsoft Entourage, Microsoft Outlook, Mozilla Thunderbird, etc.

In some embodiments, computer system 301 may store user/application data 321, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described systems and methods for detecting data leakage in an enterprise. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A computer-implemented method for detecting data leakage in an enterprise, the method comprising:
receiving, by a processor, files metadata from at least one device associated with the enterprise, wherein the files metadata comprises a plurality of file parameters;
processing, by the processor, the files metadata to generate indexed metadata, wherein the indexed metadata comprises at least one of the plurality of file parameters; and
analyzing, by the processor, the indexed metadata based on predefined leakage patterns to detect the data leakage.

2. The method of claim 1 further comprises rendering a data leakage report indicating data leakage in the enterprise, wherein the data leakage report comprises detected data leaks, potential data leaks, suspicious activities, and flagged activities.

3. The method of claim 1, wherein the plurality of files parameter comprises at least one of type of file, file location, modification date, creation date, access date, timestamps maintained within a file system, file owner, file attributes, flags, or system identifier.

4. The method of claim 1, wherein the predefined leakage patterns comprises data anomalies, unauthorized access to files, deviation from standard activities, detected data leakage incidents, replication of a file in multiple devices and sequence of file system activities on an individual device and across multiple devices.

5. The method of claim 1, wherein receiving the files metadata further comprises:
transmitting authentication parameters to the at least one device;
establishing a connection with the at least one device based on the authentication parameters; and
receiving the files metadata from the at least one device based on analysis parameters.

6. The method of claim 1, wherein analyzing the indexed metadata further comprises:
generating a view of user data activities comprising data timelines and activities; and
mapping the view with the predefined leakage patterns to detect the data leakage.

7. The method of claim 1 further comprises receiving file content, for further analysis, from the at least one device upon detecting the data leakage.

8. The method of claim 1 further comprises:
tracking a data movement pattern, for a user in the enterprise, based on the indexed metadata; and
creating a user profile, based on the data movement pattern, to indicate user behavior in the enterprise.

9. A system for detecting data leakage in an enterprise, the system comprising:
a processor operatively coupled to a memory device, wherein the processor is configured to execute instructions stored in the memory device to perform operations comprising:
receiving files metadata from at least one device associated with the enterprise, wherein the files metadata comprises a plurality of file parameters;
processing the files metadata to generate indexed metadata, wherein the indexed metadata comprises at least one of the plurality of file parameters; and
analyzing the indexed metadata based on predefined leakage patterns to detect the data leakage.

8. The system of claim 9, wherein the operations further comprise rendering a data leakage report indicating data leakage in the enterprise, wherein the data leakage report comprises detected data leaks, potential data leaks, suspicious activities, and flagged activities.

11. The system of claim 9, wherein the plurality of files parameter comprises at least one of type of file, file location, modification date, creation date, access date, timestamps maintained within a file system, file owner, file attributes, flags, or system identifier.

12. The system of claim 9, wherein the predefined leakage patterns comprises data anomalies, unauthorized access to files, deviation from standard activities, detected data leakage incidents, replication of a file in multiple devices and sequence of file system activities on an individual device and across multiple devices.

13. The system of claim 9, wherein the operations of receiving the files metadata further comprises:
transmitting authentication parameters to the at least one device;
establishing a connection with the at least one device based on the authentication parameters; and
receiving the files metadata from the at least one device based on analysis parameters.

14. The system of claim 9, wherein operations of analyzing the indexed metadata further comprises:
generating a view of user data activities comprising data timelines and activities; and
mapping the view with the predefined leakage patterns to detect the data leakage.

15. The system of claim 9, wherein the operations further comprise receiving file content, for further analysis, from the at least one device upon detecting the data leakage.

16. The system of claim 9, wherein the operations further comprise:
tracking a data movement pattern, for a user in the enterprise, based on the indexed metadata; and
creating a user profile, based on the data movement pattern, to indicate user behavior in the enterprise.

17. A non-transitory computer-readable medium storing instructions for detecting data leakage in an enterprise that, when executed by a processor, cause the processor to perform operations comprising:
receiving files metadata from at least one device associated with the enterprise, wherein the files metadata comprises a plurality of file parameters;
processing the files metadata to generate indexed metadata, wherein the indexed metadata comprises at least one of the plurality of file parameters; and
analyzing the indexed metadata based on predefined leakage patterns to detect the data leakage.

18. The computer-readable medium of claim 17, wherein the operations further comprise rendering a data leakage report indicating data leakage in the enterprise, wherein the data leakage report comprises detected data leaks, potential data leaks, suspicious activities, and flagged activities.

19. The computer-readable medium of claim 17, wherein the plurality of files parameter comprises at least one of type of file, file location, modification date, creation date, access date, timestamps maintained within a file system, file owner, file attributes, flags, or system identifier.

20. The computer-readable medium of claim 17, wherein operations of receiving the files metadata further comprises:
transmitting authentication parameters to the at least one device;
establishing a connection with the at least one device based on the authentication parameters; and
receiving the files metadata from the at least one device based on analysis parameters.

21. The computer-readable medium of claim 17, wherein the operations of analyzing the indexed metadata further comprises:
generating a view of user data activities comprising data timelines and activities; and
mapping the view with the predefined leakage patterns to detect the data leakage.

22. The computer-readable medium of claim 17, wherein the predefined leakage patterns comprises data anomalies, unauthorized access to files, deviation from standard activities, detected data leakage incidents, replication of a file in multiple devices and sequence of file system activities on an individual device and across multiple devices.
